(19) United States
(12) Patent Application Publication
(10) Pub. No.: US 2007/0131300 A1
(43) Pub. Date: Jun. 14, 2007

(54) Pipe joint insulation, apparatus and method

(76) Inventors: Richard Lounders, Tampa, FL (US); Anthony Perrone, Key Largo, FL (US)

Correspondence Address: LAW OFFICE OF CHRISTOPHER KAY, 3111 W. DR. M.L. KING JR. BLVD., SUITE 100, TAMPA, FL, 33607, US

(21) Appl. No.: 11/599,042

(22) Filed: Nov. 13, 2006

Related U.S. Application Data
(60) Provisional application No. 60/735,283, filed on Nov. 12, 2005.

(51) Int. Cl. F16L 9/14

(52) U.S. Cl. 138/149; 138/151

(57) ABSTRACT

A pipe insulating fitting cover for insulating a pipe joint, the cover having a first insulating cover for insulating the body of the pipe joint and a second insulating cover for enclosing and insulating the bonnet of the pipe joint, in which the first and second covers are mounted to each other through complementary cylindrical surfaces on their outer surfaces with an optional sealing layer between them. The invention further provides a method and apparatus for forming the cover.

### CROSS-REFERENCE

The present application claims priority from U.S. Provisional Patent Application No. 60/735,283 filed Nov. 12, 2005, the contents of which are hereby incorporated in their entirety by reference, and which is not admitted to be prior art by its mention in the background.

### BACKGROUND

This invention relates generally to pipe insulating fitting covers. More particularly, the invention relates to pipe insulating fitting covers for insulating pipe joints and to methods and apparatus for the production of pipe insulating fitting covers.

Piping systems are designed to carry a wide variety of fluids and gases at non-ambient temperatures including chilled fluids such as cold water or refrigerant, and heated fluids and gases such as hot water or steam. When fluid or gas is transported at non-ambient temperatures, it is preferable to insulate the piping to minimize energy losses and expense for maintaining the temperature of the fluid or gas.

Pipe joints can be problematic to insulate. Elbows, valves, pipe tees, strainer valves, and Y-valves, for example, all require insulating fitting covers specifically adapted to their dimensions. An insulating fitting cover is preferably devoid of breaches or other imperfections that would permit wicking of moisture, or water vapor transmission, into the insulating fitting cover and the deleterious accumulation of condensation. Because the thermal conductivity of water is about an order of magnitude higher than the thermal conductivity of the insulation materials typically used to insulate pipes, imperfections can raise the thermal conductivity of the cover and impair its long-term effectiveness. Water absorbed into the cover can add significant weight, stressing piping supports. Moisture also increases the likelihood of corrosion and of fungal and bacterial growth. Also, in cold service, water may freeze within the cover resulting in degradation of the insulation by freeze-thaw action.

Thus, efficient insulation of pipe joints requires the manufacture of insulating fitting covers of high structural integrity by methods and apparatus that are readily adaptable to diverse pipe joint dimensions. Preferably, the manufacture of insulating fitting covers is performed quickly, accurately, without requiring skilled labor, and at low cost.

Information relevant to attempts to address these problems can be found in U.S. Pat. Nos. 6,530,603; 4,807,669; 4,449,554; 5,941,287; 4,022,248; 3,631,898; and 3,585,678. However, each one of these references suffers from one or more of the following disadvantages: the insulating fitting cover must deform while being fitted to the pipe joint, limiting the choice of suitable insulating materials to only flexible insulating materials; the insulating fitting cover is designed as a universal insulation accommodating a variety of pipe joint dimensions, increasing complexity and cost; the insulating fitting cover is designed to be removable and reusable, requiring means for reversibly fastening the fitting cover; or the insulating fitting cover is individually fabricated from solid blocks of insulating material by grinding or cutting the insulation material to form a contoured cavity, increasing material and labor costs.

It is known in the art to manufacture pipe joint insulating fitting covers as sections joined by miter joints. The sections are formed by making linear cuts in tubular stock insulation material. Accurate cutting and fitting of such sections is problematic, particularly for large pipe joints or where many mitered sections are joined serially and dimensional errors accumulate. A band saw or hand saw is typically used to cut the miter joint, and play in the band saw or inaccuracies in the alignment of the piece relative to the saw can significantly degrade the quality of the resulting miter joint. Information relevant to attempts to address these problems can be found in U.S. Pat. No. 3,673,689.

Therefore, there is a need in the art for an improved pipe insulating fitting cover for pipe joints that can be simply constructed to close dimensional tolerances and which provides improved insulation and improved resistance to moisture and humidity.

### SUMMARY

The present invention is directed to a pipe joint insulation fitting cover and to an apparatus and method for its manufacture that satisfies the need for a pipe joint insulation fitting cover capable of simple and accurate construction and which provides improved thermal insulation and improved resistance to moisture and humidity.

In a first embodiment, the present invention is directed to a pipe insulating fitting cover for insulating a pipe joint, where the pipe joint comprises a bonnet portion jointed to a body portion. The pipe insulating fitting cover comprises a first insulating cover for enclosing and insulating the body. The first insulating cover has a convex outer cylindrical surface at least adjacent to the bonnet. The pipe insulating fitting cover further comprises a second insulating cover for enclosing and insulating the bonnet. The second insulating cover has a proximal end oriented toward the body and is mounted at its proximal end to the first cover. The proximal end of the second insulating cover comprises a concave cylindrical surface that is complementary to the convex cylindrical surface of the first cover, and the two covers are mounted at these complementary cylindrical surfaces. Optionally, a sealing layer is interposed between the convex and concave cylindrical surfaces. Each insulating cover can optionally comprise a plurality of cooperating insulating elements, such as, for example, a pair of substantially hemi-cylindrical insulating elements, or can be formed as one piece.

In a second embodiment, the present invention is directed to a pipe insulating fitting cover for insulating a pipe joint in which a first insulating element is provided comprising a convex cylindrical surface portion. A second insulating element is provided comprising a concave cylindrical surface portion. The convex and concave cylindrical surface portions have substantially similar radii so that they are substantially complementary. The first cylindrical surface portion is mounted to the second cylindrical surface portion to form the pipe insulating fitting cover. Optionally, a sealing layer is interposed between the convex and concave cylindrical surfaces. The insulating covers can optionally comprise a plurality of cooperating insulating elements, such as, for example, a pair of substantially hemi-cylindrical insulating elements, or can be formed as one piece.

In a third embodiment, the present invention is directed to a method for forming a pipe insulating fitting cover for insulating a pipe joint. In a first step, the body of the pipe joint is enclosed within a first insulating cover that comprises a convex outer cylindrical surface adjacent the bonnet. In a second step, the bonnet of the pipe joint is enclosed within a second insulating cover. The second insulating cover has a proximal end comprising a concave surface that is substantially complementary to the convex cylindrical surface of the first cover. In a third step, the convex surface of the first insulating cover is mounted to the concave surface of the second insulating cover. Optionally, a sealing layer is interposed between the convex and concave cylindrical surfaces.

In a fourth embodiment, the present invention is directed to an apparatus for forming the concave cylindrical surface of a second insulating cover or portion thereof of a pipe insulating fitting cover according to one of the preceding embodiments. The apparatus comprises a cylinder with an abrasive surface and a radius that is substantially similar to the outer radius of the first insulating cover. The abrasive surface can, for example, be an abrasive surface of the cylinder itself or an abrasive belt looped about the cylinder. The apparatus further comprises a means for rotating the cylinder, such as an electric motor coupled directly or indirectly to the cylinder. A planar support surface is provided that is coplanar with the rotational axis of the cylinder for supporting the first insulating cover or a portion thereof. A means for moving the support surface within its plane in directions perpendicular to the rotational axis is provided so that the support surface and a supported work piece can be moved towards or away from the abrasive surface. There is further provided a means for retaining the first insulating cover or portion thereof on the support surface at an angle to the rotational axis of the cylinder that is substantially similar to the angle of the body to the bonnet.

It is an object of the present invention to provide a pipe insulating fitting cover for insulating a pipe joint, the pipe insulating fitting cover comprising insulating covers mounted through complementary cylindrical surfaces to provide increased accuracy of fit and improved sealing.

It is another object of the present invention to provide a pipe insulating fitting cover for insulating a pipe joint that can be simply, quickly, efficiently, and inexpensively manufactured.

It is still another object of the present invention to provide a pipe insulating fitting cover for a pipe joint with improved resistance to moisture and improved thermal insulating properties in use in wet or humid environments.

It is yet another object of the present invention to provide a pipe joint pipe insulating fitting cover having improved longevity in use under freeze-thaw conditions.

### BRIEF DESCRIPTION OF THE FIGURES

These and other features, aspects, and advantages of the present invention will become better understood with regard to the following description, appended claims, and accompanying drawings where:

FIG. 1A shows an isometric view of a pipe insulating fitting cover of the prior art.

FIG. 1B shows the prior art pipe insulating fitting cover of FIG. 1A in longitudinal sectional view.

FIG. 1C shows the prior art pipe insulating fitting cover of FIG. 1A in cross-sectional view about plane A.

FIG. 2A shows an isometric view of one embodiment of the pipe insulating fitting cover according to the present invention.

FIG. 2B shows the pipe insulating fitting cover of FIG. 2A in longitudinal sectional view.

FIG. 2C shows the pipe insulating fitting cover of FIG. 2A in cross-sectional view about plane B.

FIG. 3A shows an isometric view of a second embodiment of the pipe insulating fitting cover according to the present invention in which a Y-strainer joint with flanges is insulated and the body is jointed to the bonnet at an acute angle.

FIG. 3B shows the pipe insulating fitting cover of FIG. 3A in longitudinal sectional view.

FIG. 4 shows an isometric view of a third embodiment of the pipe insulating fitting cover according to the present invention in which the cover insulates a pipe joint comprising two bonnets jointed to a single body.

FIG. 5 illustrates an embodiment of a method according to the present invention for forming a pipe insulating fitting cover.

FIG. 6A shows a side view of one embodiment of an apparatus according to the present invention for forming a pipe insulating fitting cover.

FIG. 6B shows a top view of the embodiment of an apparatus according to FIG. 6A.

### DETAILED DESCRIPTION

The term “pipe joint” refers without limitation to a body pipe (body) jointed at an intermediate position to one or more bonnet pipes (bonnets). In its most basic embodiment, a pipe joint can be a tee in which bonnet and body are perpendicular. In other embodiments, the body and bonnet form an acute angle, such embodiments including Y-valves and strainer valves, such as a strainer valve having an acute angle of about 45°-50°. The term “pipe joint” includes joints further comprising valves, flanges, sensors, blow-off valves, or other fittings associated with the bonnet or the body. The term “pipe joint” further includes pipe joints in which the centerlines of the body and bonnet may or may not intersect. The body and bonnet are not particularly limited with respect to pipe diameter and length, and the body and bonnet pipe diameters and lengths can be the same or different. The body and bonnet are not particularly limited with respect to pipe material, and pipe materials can include, for example, metal or polymer pipes.

The term “enclosing” refers without limitation to one or more cooperating insulating elements disposed about the entire circumference of a body or bonnet at one or more points along its length. The insulating elements comprise an insulating material, and can further optionally comprise an adhesive, sealant, or the like, bonded to the insulating material. The adhesive sealant is not particularly limited and can include, for example, adhesives having a neoprene or acrylic base, a tar or pitch, or adhesive impregnated sheets of a suitable support such as a paper or a polymer.

The term “hemi-cylindrical” refers without limitation to a portion of a tube or cylinder formed by a pair of longitudinal cuts in the plane of the centerline. The pair of longitudinal cuts may or may not be coplanar.

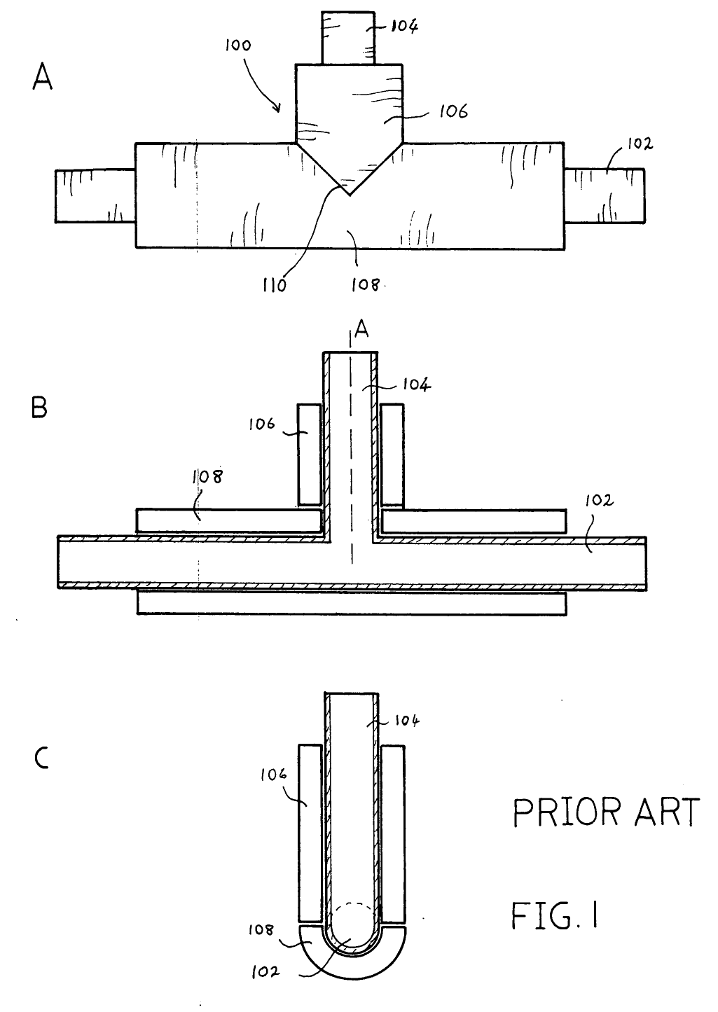

Turning now to FIG. 1, there are shown various views of an insulated pipe joint of the prior art. Insulated pipe joint 100 comprises body 102 jointed to bonnet 104. Bonnet insulation 106 and body insulation 108 are jointed by miter joint 110 and are mounted to, and surround, the pipe joint. The miter joint of the insulated pipe joint of the prior art is conventionally formed by a set of linear cuts made in tubular or hemi-cylindrical stock insulation material.

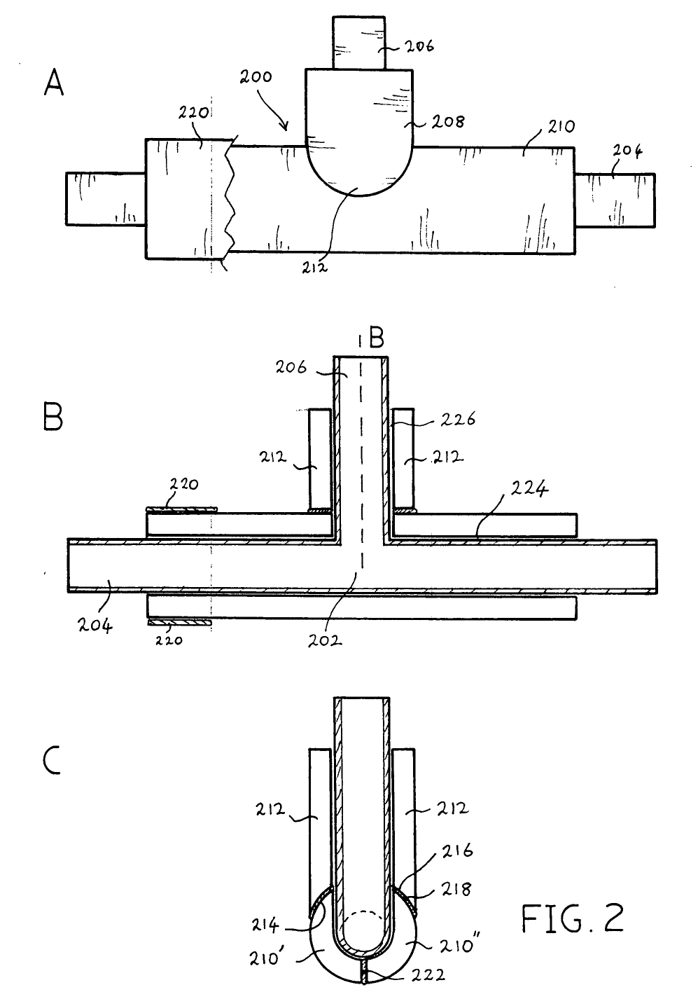

Referring now to FIG. 2, there are shown several views of one embodiment of a pipe insulating fitting cover 200 according to the present invention fitted to pipe joint 202, pipe joint 202 comprising body 204 jointed to bonnet 206. In the embodiment of FIG. 2, body 204 and bonnet 206 are jointed perpendicularly, however the present invention is not so limited, and the angle subtended by the centerlines of the body and bonnet can also be acute. Pipe insulating fitting cover 200 comprises bonnet insulating cover 208 mounted to body insulating cover 210. Bonnet insulating cover 208 comprises a proximal end 212 mounted to a substantially complementary surface 214 of body insulating cover 210. Adjacent the bonnet, body insulating cover 210 comprises a cylindrical outer surface 214 that is mounted to the proximal end 212 of bonnet insulation 208. The surface of bonnet insulating cover 208 comprises, at proximal end 212, a concave surface 216 substantially conforming to the convex cylindrical surface portion 214 of body insulating cover 208. Optionally, a layer of adhesive or other sealing compound is interposed between the convex cylindrical surface portion 214 of body insulating cover 208 and the concave surface 216 of bonnet insulating cover 208 to form sealing layer 218.

The insulation material is not particularly limited and can include, for example, polyurethane, polystyrene, foamed glass, magnesia, calcium silicate, phenolic pipe insulation, polyisocyanurate foam, glass fiber, and equivalents thereof, among other materials. In embodiments in which the proximal end of the bonnet insulation is shaped by abrasion or grinding, the bonnet insulation material can include any self-supporting rigid or semi-rigid insulating material. Preferably, the insulation material is selected to have low mass and a low K factor denoting low thermal conductivity. In preferred embodiments, the insulating material is calcium silicate.

The pipe insulating fitting cover 200 of the present invention can optionally further comprise a vapor retarding outer layer 220, for example a metallic layer, a resin layer, a polymeric layer, or the like. The vapor retarding outer layer can be bonded to the external surface of the cover or mechanically mounted to it without bonding.

The body insulating cover 210 and bonnet insulating cover 208 can each be unitary, or preferably are constructed from a plurality of cooperating insulating elements for ease of mounting to the pipe joint. For example, in the embodiment of FIG. 2., body insulating cover 210 is comprised of two cooperating hemi-cylindrical insulating elements 210′, 210″ mounted to each other by optional sealing layer 222.

It is within the scope of the present invention to shape interior surface 224 of body insulating cover 210 and/or interior surface 226 of bonnet insulating cover 208 to accommodate valves, fitting, sensors, and the like. Also, the inner diameter of an insulating cover can be selected to accommodate the pipe joint at its largest dimension, producing cavities elsewhere between the pipe insulating fitting cover and the pipe joint. For example, a pipe insulating fitting cover for a globe valve can be formed using an insulating cover having an inner diameter matching the outer diameter of the globe valve, thereby producing cavities between the pipe insulating fitting cover and the pipe joint at narrower regions of the pipe joint, which can optionally be filled with an insulating material.

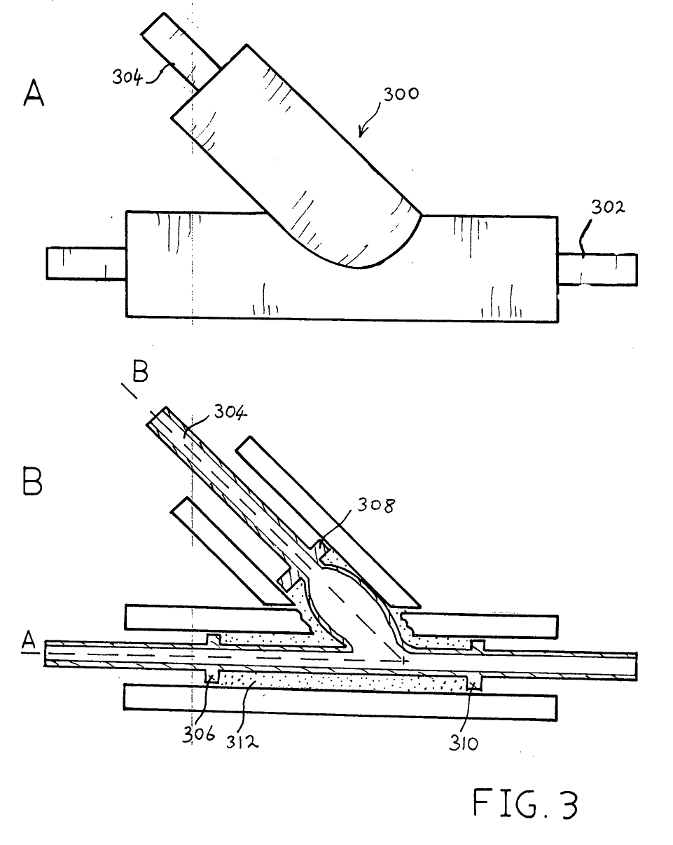

Referring now to FIG. 3, an embodiment of the pipe insulating fitting cover 300 of the present invention is shown in which centerline A of body 302 and centerline B of bonnet 304 intersect at an acute angle. It is not essential to the present invention, however, that the centerlines of body and bonnet intersect. Non-intersection produces an offset joint, which can also be insulated by a pipe insulating fitting cover according to the present invention. The body and bonnet of the embodiment of FIG. 3 further comprise flanges 306, 308, 310, thereby producing cavities within pipe insulating fitting cover 300, which can optionally be filled in sum or in part by an insulating material 312, for example by a settable expanding insulating foam. It will be readily apparent to one of ordinary skill in the art that a wide variety of pipe fittings, sensors, valves, and the like can be accommodated.

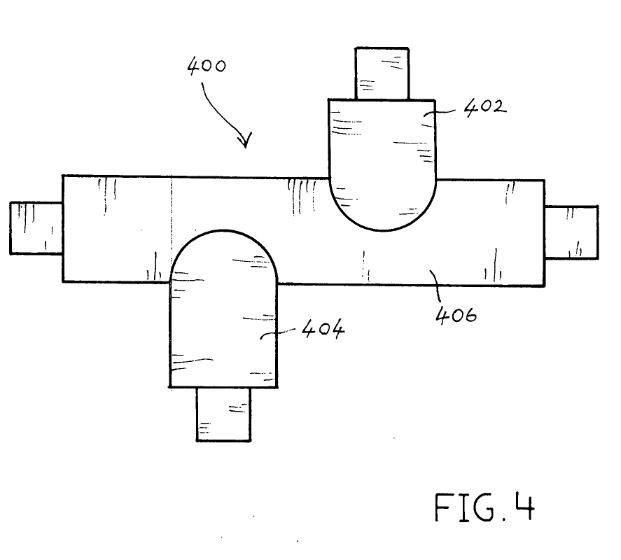

Turning now to FIG. 4, an embodiment of the pipe insulating fitting cover 400 of the present invention is shown in which the pipe cover comprises two bonnet insulating covers 402, 404 mounted to one body insulating cover 406. It will be readily understood by one of ordinary skill upon reviewing FIG. 4 that the pipe insulating fitting cover of the present invention can be adapted to a wide range of pipe joints of varying complexity, or to combinations of pipe joints.

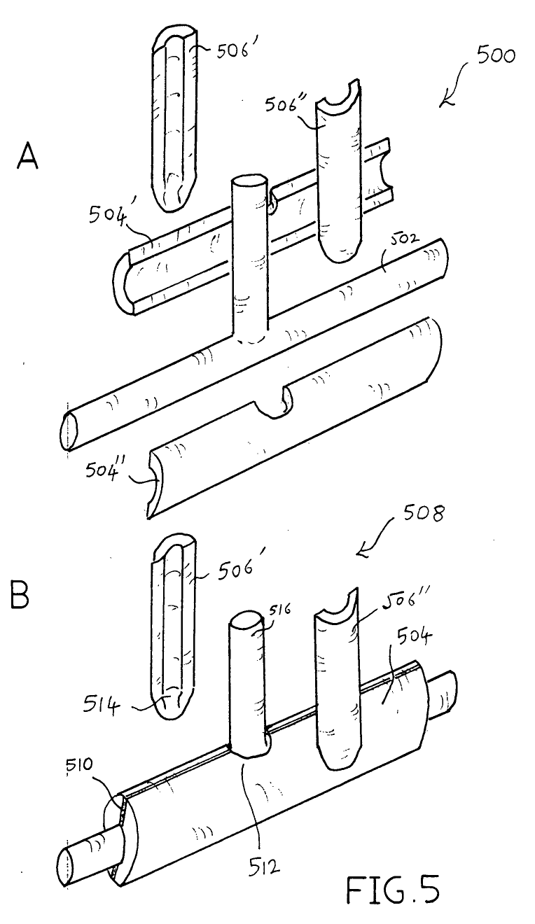

Referring now to FIG. 5, two views of an embodiment of the pipe insulating fitting cover according to the present invention are shown in unassembled 500 and partially assembled 508 form to illustrate the process of assembly. In this embodiment, the body insulating cover 504 is formed from two hemi-cylindrical cooperating insulating elements 504′, 504″ from which semicircular portions have been removed to accommodate the bonnet of the pipe joint.

In a first assembly step, the two hemi-cylindrical cooperating insulating elements 504′, 504″ can be mounted to each other and to pipe joint body 502 to form partially assembled form 508. An optional sealing layer 510 can be interposed between the hemi-cylindrical cooperating insulating elements 504′, 504″.

In a second assembly step, the two hemi-cylindrical cooperating insulating elements 506′, 506″ comprising bonnet insulating cover are mounted the bonnet 516 and to body insulating cover 504 via the convex outer cylindrical surface portion 512 of the body insulating cover 504 and the substantially complementary convex cylindrical surface portion 514 of the bonnet insulating cover 506.

Convex cylindrical surface portion 514 of the bonnet insulating cover 506 can be formed by any suitable method known in the art, including but not limited to grinding, sanding, cutting, or molding. In a preferred embodiment, the proximal end of the bonnet insulation is formed by contacting a rotating abrasive cylinder whereby the proximal end is shaped to conform to a cylindrical surface of appropriate radius. The proximal end of the bonnet insulation can be contacted to a rotating abrasive cylinder in the form of a unitary cylindrical piece, or in the form of two hemi-cylindrical pieces abraded separately.

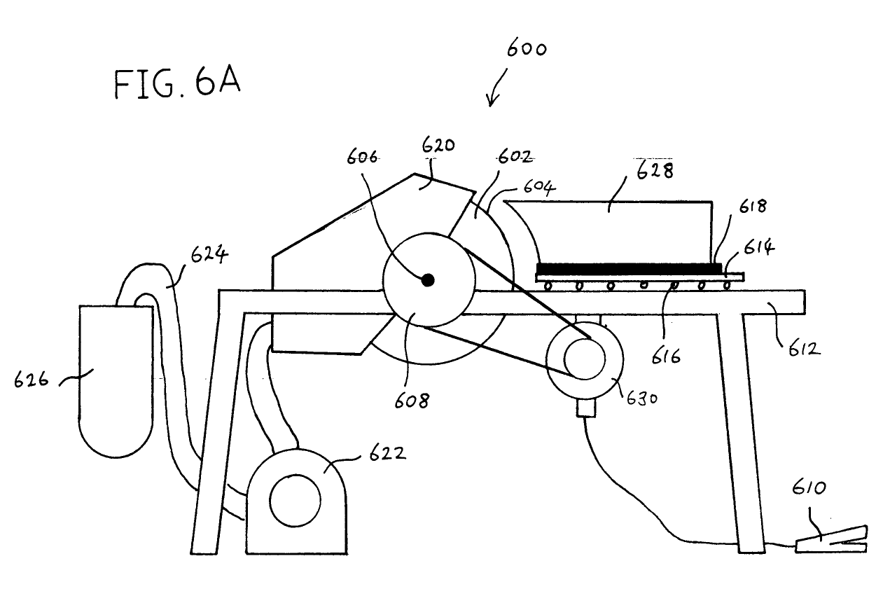

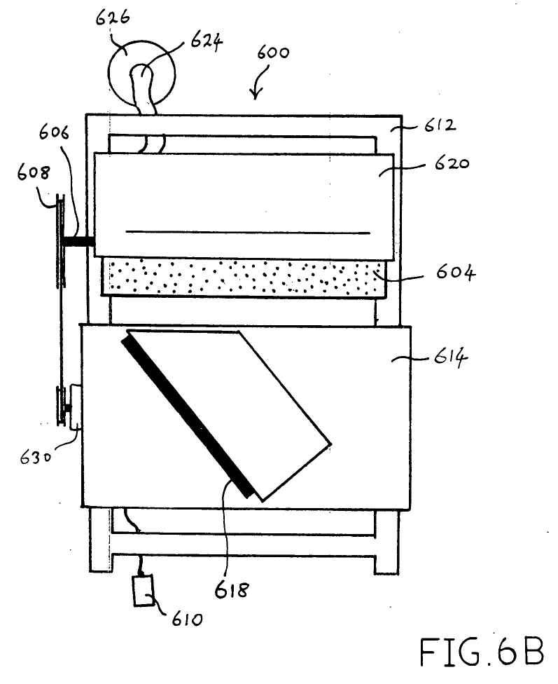

Referring now to FIG. 6, the present invention further provides an apparatus 600 for rapidly, accurately, and inexpensively forming the concave cylindrical surface of a bonnet insulating cover. The apparatus comprises a rotating cylinder 602 comprising an abrasive surface 604, the radius of the cylinder being selectable to match the radius of the body insulating cover to which the bonnet insulating cover is to be mounted. The apparatus further comprises a means for rotating the cylinder 602, for example, the cylinder can be equipped with a shaft 606, rotational bearings, and a pulley 608 for driving by an electric motor 630 controlled by a foot pedal 610. The means for rotating the cylinder can also include: a pulley, motor, and belt in which the belt can be the same as or separate from an abrasive belt used to shape the insulation; a motor and drive optionally comprising selectable gears or electronics for providing variable rotational speed of the cylinder; or a manual drive, such as a crank and chain. Preferably, the means for rotating the cylinder is capable of rotating the cylinder at between about 200 rpm and about 300 rpm.

Cylinder 602 can, for example, be constructed from plurality of disks attached to a shaft to support an abrasive surface mounted to the circumference of the disks to form the abrasive surface 604. The material of the disks is not particularly limited and may be for example wood or a polymer. The radius of the disks, and thereby the radius of the abrasive cylinder, is selected to match the radius of the cylindrical portion of the body insulation. The abrasive surface mounted to the disks can be sandpaper, other abrasive particles affixed to the cylinder, an abrasive belt, a metal lathe equipped with rotating cutting tool(s), or other abrasive surface. For example, the abrasive surface can comprise 40-grit abrasive. The bearings are preferably mounted to a bench 612 or other stable surface.

The apparatus of FIG. 6 further comprises a planar support surface 614 parallel to the rotational axis of the cylinder 602 for supporting the insulating cover to be abraded. The planar support 614 is mounted to a means for moving the support surface 616 within the plane of the support surface and perpendicular to the axis of cylinder rotation in order to move the insulating cover towards and away from abrasive surface 604. The means for moving the support surface within the plane of the support surface can include, for example, sliding bearings, a pair of worm drive mechanisms or other translational mechanisms disposed substantially perpendicular and parallel to the axis of rotation of the cylinder; or a roller bearing 616 permitting translation of support 614.

The apparatus further comprises a means 618 for retaining the insulating cover on the support surface in the correct orientation relative to the cylinder. The correct orientation is determined by the angle formed by the centerlines the body and bonnet to be insulated. The means for retaining the insulation cover 628 on the support surface to contact the cylinder can include, for example, pegs affixed to the support surface; or a linear guide surface 618 perpendicular to the support surface and affixed to it. The linear guide surface is optionally adjustable to vary the angle at which the insulation piece contacts the cylinder.

Optionally, the apparatus can further comprise a means for moving the support surface vertically with respect to the rotational axis of the cylinder and such means can include, for example, a worm drive mechanism capable of displacing the support surface in a perpendicular direction relative to its plane; or a series of discrete predetermined holders capable of maintaining the support surface in a plurality of predetermined locations with respect to the rotational axis.

Optionally and preferably, the apparatus of the present invention is provided with a means for removing airborne particles produced by the apparatus during operation, to provide an operator with protection from the dust. For example, a metal shroud 620 with, for example, a clam-shaped cross-section may be provided to cover a portion of the rotating cylinder, the shroud operably connected to a fan 622 capable of drawing the dust away from the shroud via pipe 624 into a dust collection receptable such as bag 626. Preferable the clam-shaped shroud is adjustable, for example by a hinge, to accommodate rotating cylinders of different diameters. The shroud can also comprise means for removing particles from the cylinder surface, for example a brush or a material lightly contacting the rotating surface.

In use, a tubular or hemi-cylindrical insulation piece is placed upon the planar support surface and retained at an angle corresponding to the angle of the pipe joint, and the planar support surface is moved perpendicularly towards the rotating cylinder to contact the abrasive cylinder whereby the concave cylindrical surface of the proximal end is formed by abrasion. Optionally, the end of the insulation piece can be trimmed to approximately the desired shape prior to abrading, for example by a single oblique saw cut. An optional stop can be provided to prevent the planar support surface from contacting the rotating cylinder.

The apparatus of present invention is not limited to the abrading of hemi-cylindrical portions and is, for example, readily adaptable to abrading whole tubular insulation by adjusting the plane of the support surface such that the centerline of the tubular insulation and the rotational axis of the rotating abrasive cylinder are in the same relative orientation as the centerlines of the body and bonnet of the pipe joint. It should be further noted that the present method is not limited to pipe joints in which the centerlines of the body and bonnet intersect. In embodiments in which the centerlines of the body and bonnet of the pipe joint do not intersect (an offset joint), it is required to match the relative orientations of the body and bonnet centerlines to the insulation centerline and rotational axis of the abrasive cylinder by appropriate vertical positioning of the support surface with respect to the rotational axis of the cylinder.

The advantages of the present invention include, but are not limited to an improved pipe joint cover providing an improved fit between body insulation and bonnet insulation compared to the mitered joints of the prior art. The improved fit improves thermal insulation and reduced the likelihood that moisture, water vapor, or condensation, enters and damages the cover. In addition, the improved fit reduces the requirement for filler materials such as pitch or asphalt that are often used to fill spaces in conventional miter joints. The use of excess filler material can lead to difficulty in meeting smoke emission standards. The advantages of the present invention therefore also include reduced smoke emission and the avoidance of the difficulties and expense of applying pitch or asphalt, which must be maintained within a narrow range of high temperatures for application. The improved pipe joint can be simply and accurately constructed using an apparatus provided by the present invention, whereby savings in time and material, and improvements in consistency of fit, are realized.

Although the present invention has been described in considerable detail, with reference to certain preferred versions there of, other versions are also possible. Therefore, the spirit and scope of the appended claims should not be limited to the description of the preferred versions contained herein.

Now that the invention has been described:

What is claimed is:

1. A pipe insulating fitting cover for insulating a pipe joint comprising a bonnet jointed to a body, the pipe insulating fitting cover comprising:
a first insulating cover for enclosing the body, the first insulating cover comprising a convex outer cylindrical surface adjacent the bonnet; and
a second insulating cover for enclosing the bonnet, the second insulating cover mounted at its proximal end to said first cover, the proximal end comprising a concave cylindrical surface complementary to the convex cylindrical surface of said first cover.

2. The pipe insulating fitting cover of claim 1, further comprising a sealing layer interposed between said convex and concave cylindrical surfaces.

3. The pipe insulating fitting cover of claim 1, in which one or more of said insulating covers comprises a plurality of cooperating insulating elements.

4. The pipe insulating fitting cover of claim 3, in which said cooperating insulating elements comprise two substantially hemi-cylindrical insulating elements.

5. The pipe insulating fitting cover of claim 1, in which the body is perpendicular to the bonnet.

6. The pipe insulating fitting cover of claim 1, in which the body and the bonnet are jointed at an acute angle.

7. The pipe insulating fitting cover of claim 1, wherein a second bonnet is jointed to the body, the first insulating cover further comprising a second outer cylindrical surface adjacent the second bonnet, and the pipe insulating fitting cover further comprising a third insulating cover substantially enclosing the second bonnet and contacting said first cover at a proximal end, the proximal end comprising a concave surface substantially complementary to the second cylindrical surface of said first cover.

8. The pipe insulating fitting cover of claim 1, in which at least one of said insulating covers comprises an insulating material selected from the group consisting of polyurethane, polystyrene, foamed glass, magnesia, calcium silicate, phenolic pipe insulation, polyisocyanurate foam, glass fiber, and a combination thereof.

9. The pipe insulating fitting cover of claim 1, further comprising a vapor retarding outer layer.

10. An insulated pipe joint comprising a pipe insulating fitting cover according to claim 1 substantially enclosing a pipe joint.

11. A pipe insulating fitting cover comprising:
a first insulating element comprising a convex cylindrical surface portion; and
a second insulating element comprising a concave cylindrical surface portion, the radii of the convex and concave cylindrical surface portions substantially similar, the first cylindrical surface portion mounted to the second cylindrical surface portion.

12. The pipe insulating fitting cover of claim 11, in which the first and second cylindrical portions are attached by a sealing layer.

13. A method for forming a pipe insulating fitting cover for insulating a pipe joint comprising a bonnet jointed to a body, the method comprising:
(a) enclosing the body with a first insulating cover comprising a convex outer cylindrical surface adjacent the bonnet;
(b) enclosing the bonnet with a second insulating cover having a proximal end, the proximal end comprising a concave surface substantially complementary to the convex cylindrical surface of said first cover; and
(c) mounting the convex surface of the first insulating cover to the concave surface of the second insulating cover.

14. The method of claim 13, in which step (c) further comprises interposing a sealing layer between the convex and concave cylindrical surfaces.

15. An apparatus for forming the concave cylindrical surface of a second insulating cover or portion thereof of a pipe insulating fitting cover according to claim 1, the apparatus comprising:
(a) a cylinder comprising an axis of rotation, an abrasive surface, and a radius substantially similar to the radius of the first insulating cover;
(b) means for rotating the cylinder;
(c) a planar support surface coplanar with the rotational axis for supporting the first insulating cover or a portion thereof;
(d) means for moving the support surface within the plane of the support surface and in directions perpendicular to the rotational axis; and
(e) means for retaining the first insulating cover or portion thereof on said support surface at an angle to the rotational axis that is substantially similar to the angle of the body to the bonnet.

16. The apparatus of claim 15, in which the abrasive surface is a belt disposed about the cylinder.

17. The apparatus of claim 15, in which the abrasive surface comprises abrasive particles.

18. The apparatus of claim 15, in which the means for moving the support surface are rollers mounted between the support surface and a fixed support.

19. The apparatus of claim 15, further comprising means for drawing airborne particles produced by the cylinder away from a user.
